(19) United States
(12) Patent Application Publication
(10) Pub. No.: US 2025/0188941 A1
(43) Pub. Date: Jun. 12, 2025

(54) CLOSED LOOP POWER CONTROL FOR BLOWERS

(71) Applicant: Milwaukee Electric Tool Corporation, Brookfield, WI (US)

(72) Inventors: Adam F. Czerwonka, Mukwonago, WI (US); Richard A. Behnke, Milwaukee, WI (US); Vidisha Singhal, West Lafayette, IN (US)

(21) Appl. No.: 18/971,129

(22) Filed: Dec. 6, 2024

Related U.S. Application Data
(60) Provisional application No. 63/607,164, filed on Dec. 7, 2023.

(51) Int. Cl. F04D 25/06; A01G 20/47; F04D 27/00

(52) U.S. Cl. CPC F04D 25/06; A01G 20/47; F04D 27/004

(57) ABSTRACT

A blower is provided. The blower includes a blower housing, a motor for driving a fan disposed within the blower housing, and a controller disposed in the blower housing and electrically coupled to the motor for controlling a power output of the motor. The controller is configured to perform a plurality of operations. The plurality of operations include receiving a power setpoint, receiving a measured power, comparing the power setpoint and the measured power to obtain a power difference, generating a control signal based on the power difference, and adjusting the power output of the motor based on the control signal.

### CROSS-REFERENCE TO RELATED APPLICATIONS

This application is a non-provisional application claiming the benefit of priority under 35 U.S.C. § 119(e) to U.S. Provisional Application No. 63/607,164, filed on Dec. 7, 2023, which is hereby incorporated by reference in its entirety.

### FIELD

The present disclosure relates generally to outdoor power tools such as blowers.

### BACKGROUND

Outdoor tools such as blowers are commonly used to concentrate debris, e.g., leaves, using a blowing function. Various nozzles or attachments may be coupled to the blower to achieve a desired effect. However, the nozzles or attachments can negatively impact the output of the blower.

Accordingly, improved blowers are desired in the art. In particular, blowers which provide a constant output of air across attachments would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a blower is provided. The blower includes a blower housing, a motor for driving a fan disposed within the blower housing, and a controller disposed in the blower housing and electrically coupled to the motor for controlling a power output of the motor. The controller is configured to perform a plurality of operations. The plurality of operations include receiving a power setpoint, receiving a measured power, comparing the power setpoint and the measured power to obtain a power difference, generating a control signal based on the power difference, and adjusting the power output of the motor based on the control signal.

In accordance with another embodiment, a method for controlling a motor of a blower is provided. The method includes receiving a power setpoint, receiving a measured power, comparing the power setpoint and the measured power to obtain a power difference, generating a control signal based on the power difference, and adjusting a power output of the motor based on the control signal.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1A is a perspective view of a blower in accordance with embodiments of the present disclosure;

FIG. 1B is a side view of the blower of FIG. 1A in accordance with embodiments of the present disclosure;

FIG. 2 is a cross-section view of a portion of the blower of FIGS. 1A-1B in accordance with embodiments of the present disclosure;

FIG. 3A is a perspective view of a flat nozzle attachment for the blower of FIGS. 1A-1B in accordance with embodiments of the present disclosure;

FIG. 3B is a perspective view of a narrow nozzle attachment for the blower of FIGS. 1A-1B in accordance with embodiments of the present disclosure;

FIG. 4 is a schematic diagram of a power control module in accordance with embodiments of the present disclosure;

FIG. 5 is a graph illustrating two operating modes of a blower in accordance with embodiments of the present disclosure;

FIG. 6 is a flow chart of a method of operating a blower in accordance with embodiments of the present disclosure;

FIG. 7 is a flow chart of a method of operating a blower in accordance with embodiments of the present disclosure; and

FIG. 8 is a block diagram of an example of a computing system in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, when different nozzle attachments are added to a blower, blower output may be negatively impacted. For example, some nozzle attachments may cause rotational speed of a fan associated with a motor to decrease, thereby decreasing an output of air (such as in cubic feet per minute) from the blower. However, operating the motor at a constant power output, such as by using a closed loop power control module, can ensure that the output of the blower remains constant regardless of whether a nozzle attachment is used and regardless of the type of nozzle attachment used.

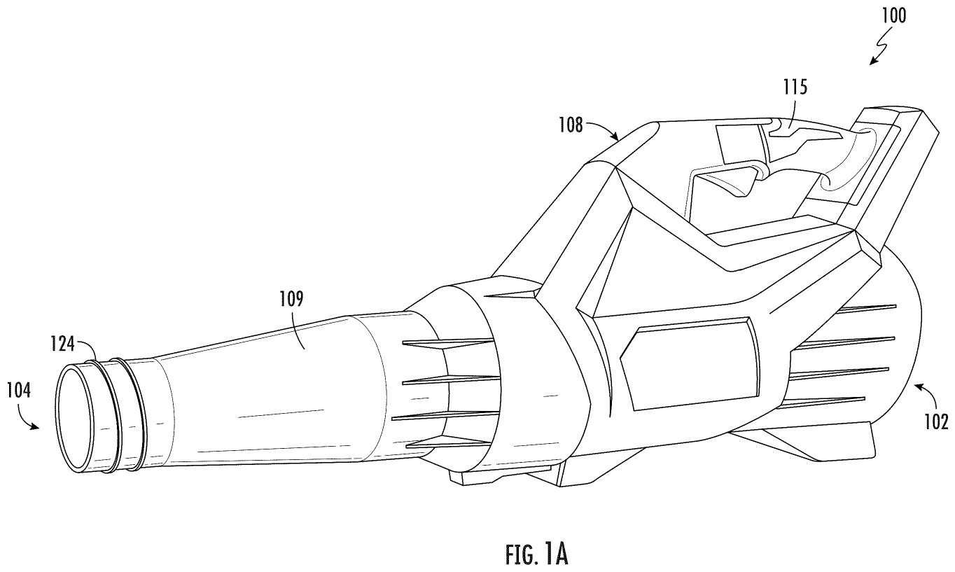

Referring now to the drawings, FIG. 1A illustrates a perspective view of a blower in accordance with embodiments of the present disclosure. FIG. 1B illustrates a side view of the blower of FIG. 1A in accordance with embodiments of the present disclosure.

In at least one example embodiment, a blower 100 includes a blower housing 108 defining an air inlet 102 and an air outlet 104. The blower 100 may also include a blower tube 109 removably coupled to the blower housing 108. The blower tube 109 may define at least a portion of the air outlet 104. The blower 100 is configured to generate airflow along an airflow conduit 106 extending between the air inlet 102 and the air outlet 104. For example, the airflow conduit 106 may extend from the air inlet 102 through the blower housing 108 and the blower tube 109 to the air outlet 104, as shown in FIG. 1B.

In at least one example embodiment, blower 100 is provided as a standard handheld blower having a cordless battery powered power source. For example, the blower housing 108 includes a handle 115. A power source 116 may be removably coupled to the blower housing 108. For example, the power source 116 may include one or more batteries removably coupled to a portion of the handle 115 of the blower housing 108. In other example embodiments, the blower 100 may include a corded electric power source and/or a gas power source. In still other example embodiments, the blower 100 may be provided as a standard backpack blower (not shown) adapted to be worn on a user's back and having a cordless battery power source.

In at least one example embodiment, the blower 100 is configured to receive a nozzle attachment 126. The nozzle attachment 126 may be removably coupled to the blower tube 109 adjacent the air outlet 104. For example, the blower tube 109 may include a plurality of threads 124 configured to engage the nozzle attachment. In other example embodiments, the nozzle attachment 126 may be secured to the blower tube 109 by other means, such as by a latch engagement. In still other example embodiments, the nozzle attachment 126 may be integral with the blower tube 109.

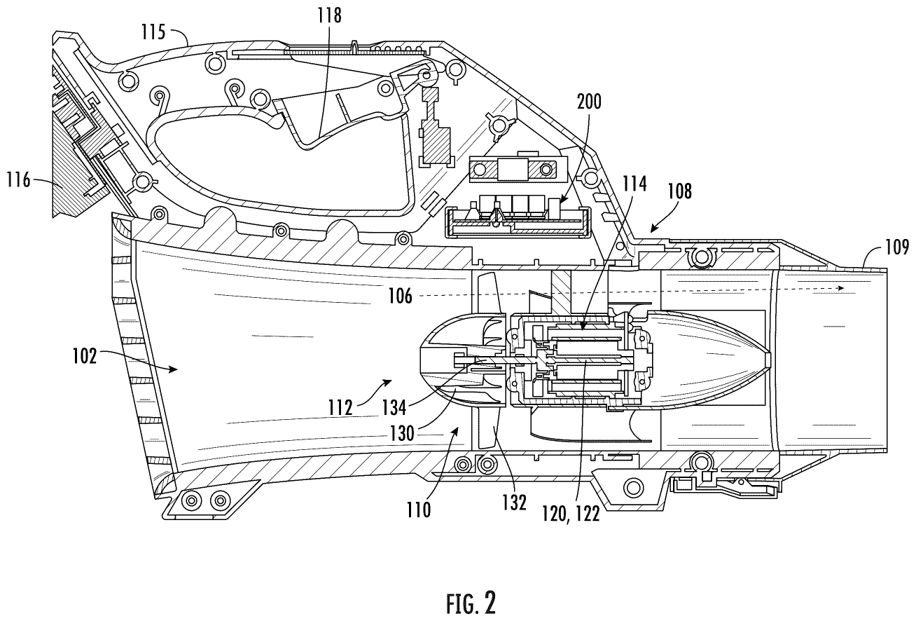

In at least one example embodiment, the nozzle attachment 126 is a standard nozzle, as shown in FIG. 1B. In other example embodiments, various types of the nozzle attachment 126 may be removably coupled to the blower tube 109, as will be discussed below with respect FIGS. 3A-3B.

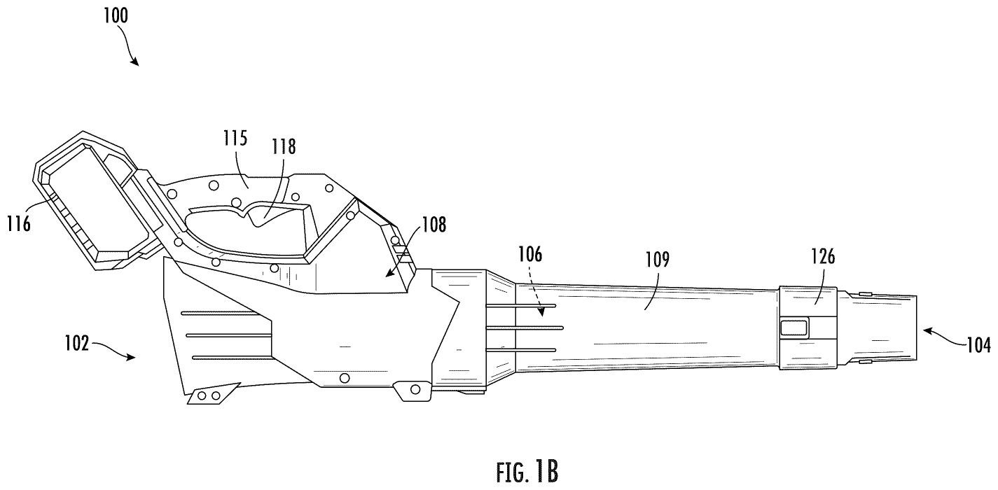

FIG. 2 illustrates a cross-section view of a portion of the blower of FIGS. 1A-1B in accordance with embodiments of the present disclosure.

In at least one example embodiments, the blower housing 108 may at least partially enclose components of the blower 100 such as an airflow generation assembly 110 including a fan 112 and a motor 114 that drives the fan 112, as well as various other components. Power to operate the airflow generation assembly 110 may be provided by the power source 116, such as one or more batteries removably coupled to the blower housing 108.

In at least one example embodiment, the airflow generation assembly 110 may have an axial configuration. For example, the fan 112 and the motor 114 may be within the blower housing 108 between the air inlet 102 and the air outlet 104 and oriented along a central axis 120 of the airflow conduit 106. Rotation of the motor 114 causes rotation of a motor shaft 122 extending along the central axis 120. The motor shaft 122 is coupled to the fan 112. In this manner, rotation of the motor shaft 122 causes rotation of the fan 112.

In at least one example embodiment, the fan 112 includes a hub 130 and a plurality of blades 132. The hub 130 may have a generally circular cross-sectional shape and may extend along the central axis 120. The motor shaft 122 is coupled to the hub 130 and/or a fan drive shaft 134 to enable transmission of rotation from the motor 114 to the hub 130 or the fan drive shaft 134 and ultimately to the blades 132.

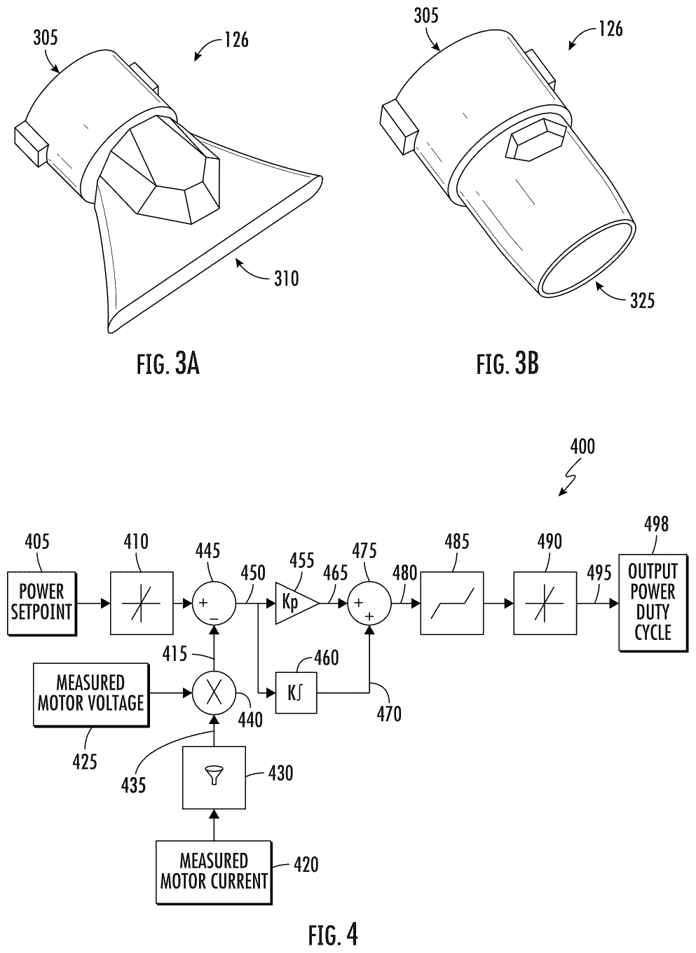

In at least one example embodiment, control electronics, such as a controller 200, are disposed within the blower housing 108 and configured to control the motor 114 and the fan 112, as will be discussed in greater detail with respect to FIG. 4, below. For example, the controller 200 may be disposed within the blower housing 108 adjacent the handle 115.

In at least one example embodiment, a trigger 118 may be disposed in the handle 115. The trigger 118 may be electrically coupled to the motor 114, the power source 116, and/or the controller 200, and may be configured to control operation of the blower 100 by activating and deactivating the motor 114. In at least one example embodiment, the trigger 118 may be used by an operator to select and adjust a desired power output of the blower 100. In other example embodiments, the trigger 118 may be used by the operator to select and adjust a rotational speed of the fan 112 of the motor 114.

FIG. 3A illustrates a perspective view of a flat nozzle attachment for the blower of FIGS. 1A-1B in accordance with embodiments of the present disclosure. FIG. 3B illustrates a perspective view of a narrow nozzle attachment for the blower of FIGS. 1A-1B in accordance with embodiments of the present disclosure.

In at least one example embodiment, the nozzle attachment 126 is a flat nozzle attachment (shown in FIG. 3A). The flat nozzle attachment includes a first end 305 and a second end 310 opposite the first end 305. The flat nozzle attachment may be removably coupled to the blower tube 109 at the first end 305. In at least one example embodiment, a height of the flat nozzle attachment may decrease from the first end 305 to the second end 310. Additionally, or alternatively, a width of the flat nozzle attachment may increase from the first end 305 to the second end 310. For example, the width of the flat nozzle attachment may increase from a middle portion of the flat nozzle attachment to the second end 310, as shown in FIG. 3A.

In at least one example embodiment, the nozzle attachment 126 is a narrow nozzle attachment (shown in FIG. 3B). The narrow nozzle attachment includes a first end 320 and a second end 325 opposite the first end 320. The narrow nozzle attachment may be removably coupled to the blower tube 109 at the first end 320. In at least one example embodiment, a diameter of the narrow nozzle attachment decreases from the first end 320 to the second end 325.

In other example embodiments, the nozzle attachment 126 comprises a restricting nozzle, a tapered nozzle, a flared nozzle, and angle flared nozzle, or a gutter attachment.

FIG. 4 illustrates a schematic diagram of a power control module in accordance with embodiments of the present disclosure.

In at least one example embodiment, the controller 200 of the blower 100 include a closed loop power control module 400. The closed loop power control module 400 is configured to maintain a constant power output by the motor 114. For example, the power output by the motor 114 may be constant regardless of whether the nozzle attachment 126 is attached to the blower tube 109 and regardless of the type of the nozzle attachment 126 attached to the blower tube 190, such as the flat nozzle attachment (shown in FIG. 3A) and the narrow nozzle attachment (shown in FIG. 3B). In at least one example embodiment the closer loop power control module 400 comprises a proportional and integral controller (“PI controller”).

In at least one example embodiment, the closed loop power control module 400 receives a power setpoint 405. The power setpoint 405 may be a desired power output set by an operator of the blower 100. For example, the power setpoint 405 may be set by the operator using the trigger 118, as discussed above with respect to FIG. 2. Additionally, a slew limit may be applied to the power setpoint 405 by a slew limiter 410. The slew limiter 410 receives the power setpoint 405 and is configured to limit a rate of change of a voltage output by the motor 114 of the blower 100. For example, the voltage output by the motor 114 is increased over a period of time until the power setpoint 405 is reached.

Moreover, the closed loop power control module 400 receives a measured power 415 that is output by the motor 114. The measured power 415 may be obtained by receiving a measured motor current 420 and a measured motor voltage 425 from the motor 114. The closed loop power control module 400 may be configured to filter the measured motor current 420 to provide a smooth reading. For example, the measured motor current 420 may be supplied to a filter 430 to obtain a filtered current output 435.

In at least one example embodiment, the filter 430 is a low-pass filter. For example, the filter 430 may be an exponential moving average (“EMA”) filter. The EMA filter is a low-pass filter that depends on the most recent input value and previous output value. The EMA filter is based on the following equation:

$$y [ n ] = α * x [ n ] + ( 1 - α ) * y [ n - 1 ]$$

where a is determined by the following equation:

$$\frac{2 π * {f}_{c}}{{f}_{s}} = {cos}^{- 1} ( \frac{{α}^{2} + 2 α - 2}{2 α - 2} )$$

where f_{c} is a cutoff frequency and fₛ is a sampling frequency. In other example embodiments, the filter 430 may include a Butterworth filter, a Chebyshev Filter, or a simple moving average filter.

Still referring to FIG. 4, a multiplier 440 may receive the measured motor voltage 425 and the filtered current output 435. The multiplier 440 multiplies the measured motor voltage 425 and the filtered current output 435 to obtain the measured power 415.

In at least one example embodiment, the power setpoint 405 and the measured power 415 are provided to a summation module 445. The summation module 445 is configured to obtain a power difference 450 between the power setpoint 405 and the measured power 415. A control signal may be generated based on the power difference 450. For example, if there is no difference between the power setpoint 405 and the measured power 415, such as when the power difference 450 is about 0, the current operation of the blower 100 may be maintained. However, if there is a difference between the power setpoint 405 and the measured power 415, the operation of the blower 100 may be adjusted, such as by adjusting the power output of the motor 114, as will be described below.

In at least one example embodiment, the power difference 450 is applied to an amplifier 455 and/or an integrator 460. The amplifier 455 is configured to apply a gain to the power difference 450 to obtain a first signal 465. The power difference is integrated by the integrator 460 to obtain a second signal 470. The first signal 465 and the second signal 470 are combined at 475 to obtain a control signal 480.

In at least one example embodiment, the control signal 480 is provided to an output limiter 485 and/or a slew limiter 490. The output limiter 485 is configured to control a voltage of the control signal 480. For example, the output limiter 485 prevents a voltage value of the control signal 480 from exceeding a threshold. Additionally, or alternatively, the slew limiter 490 controls a rate of change of the voltage of the control signal 480. For example, the slew limiter 490 may be similar or analogous to the slew limiter 410.

Moreover, the control signal 480 is output to the motor 114 at 495. The control signal 480 may instruct the motor 114 to adjust the power output by the blower 100 by adjusting the voltage output of the motor 114. For example, the control signal 480 may cause the voltage supplied to the motor 114 to increase or decrease based on the output of the output limiter 485 and/or the slew limiter 490 in order to reach the power setpoint 405. In some example embodiments, the control signal 480 includes a duty cycle command 498 output to the motor 114. In other example embodiments, the power output by the motor 114 may be adjusted by changing a rotational speed of the fan 112 of the motor 114. For example, the control signal 480 may cause the rotational speed of the fan 112 to increase if the measured power 415 is less than the power setpoint 405 or the control signal 480 may cause the rotational speed of the fan 112 to decrease if the measured power 415 is greater than the power setpoint 405. The closed loop power control module 400 of the controller 200 may continuously compare the power setpoint 405 and the measured power 415 to maintain a constant power output by the motor 114. Moreover, while the power output by the motor 114 may remain constant, the rotation speed of the fan 112 may fluctuate (increase or decrease) to maintain the constant power output.

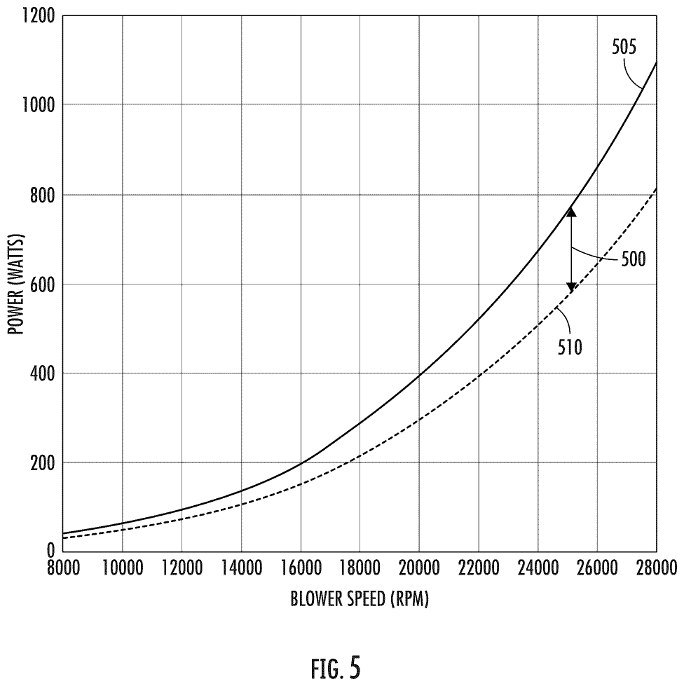

FIG. 5 is a graph illustrating two operating modes of a blower in accordance with embodiments of the present disclosure.

In at least one example embodiment, a desired power range 500 includes an upper threshold 505 and a lower threshold 510. The upper threshold 505 is a function of maximum rotations per minute of the fan 112 and the power output by the motor 114. The lower threshold 510 is a function of minimum rotations per minute of the fan 112 and the power output by the motor 114. If the power output by the motor 114 is within the desired power range 500 defined by the upper threshold 505 and the lower threshold 510, then the output of the blower 100, such as the cubic feet per minute of air exiting the blower tube 109, has remained constant. Moreover, when the power output is within the desired power range 500, the controller 200 may operate the blower 100 in the first operating mode. The first operating made may include a closed loop on the rotational speed of the fan 112 of the motor 114.

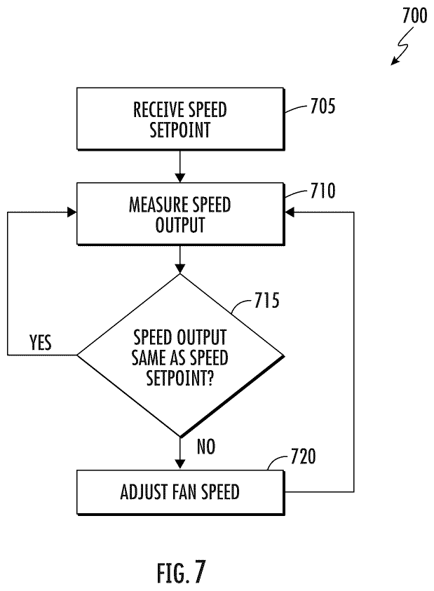

In at least one example embodiment, if the power output by the motor 114 is outside the desired power range 500, such as when the power output falls below the lower threshold 510, the controller 200 may adjust a speed setpoint of the motor 114. For example, the controller 200 may increase or decrease the rotational speed of the fan 112 of the motor 114. Adjusting the rotational speed of the fan 112 of the motor 114 may increase the power output of the motor 114 such that the power output is within the desired speed range 500. After adjusting the rotational speed of the fan 112 of the motor 114, the controller 200 may continue operating in the first operating mode, as will be discussed with respect to FIG. 7, below.

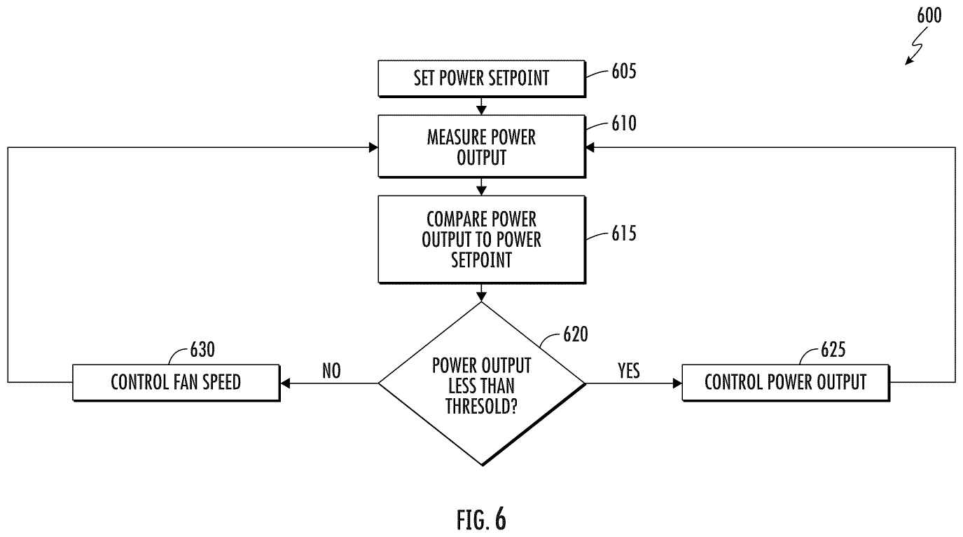

In at least one example embodiment, if the power output by the motor 114 drops below the lower threshold 510, a low flow condition may be detected. A low flow condition may occur when a nozzle attachment, such as the nozzle attachment 126, is coupled to the blower 100. When a low flow condition is detected, such as when the power output by the motor 114 drops below the lower threshold 510, the controller 200 may operate the motor in the second operating mode, as will be discussed with respect to FIG. 6, below. The second operating mode may be a closed loop on the power output of the motor 114.

FIG. 6 illustrates a flow chart of a method of operating a blower in accordance with embodiments of the present disclosure.

In at least one example embodiment, a method 600 of operating a blower, such as the blower 100, includes setting a power setpoint at 605, measuring a power output at 610, and comparing the power output to the power setpoint at 615. The method 600 may also include determining if the power output is less than a threshold at 620. If the power output is less than the threshold at 620, the method 600 may include controlling the power output at 625. If the power output is not less than the threshold at 620, the method 600 may include controlling a rotational speed of a fan of the motor at 630. One or more portions of the method 600 may be implemented by one or more computing devices, such as the controller 200.

In at least one example embodiment, setting a power setpoint at 605 includes setting a desired power output of the motor 114. For example, the power setpoint 405 may be set by the operator using the trigger 118, as discussed above with respect to FIG. 2. Additionally, a slew limit may be applied by the slew limiter 410, as shown and described with respect in FIG. 4.

In at least one example embodiment, measuring a power output at 610 includes receiving the measured power 415 output by the motor 114. Receiving the measured power 415 may include receiving a measured motor current 420, receiving a measured motor voltage 425 from the motor 114, applying a filter to the measured motor current 420 using the filter 430 to obtain the filtered current output 435, and multiplying the measured motor voltage 425 by the filtered current output 435.

In at least one example embodiment, comparing the power output to the power setpoint at 615 includes calculating the power difference 450 between the power setpoint 405 and the measured power 415 at 445.

In at least one example embodiment, the blower 100 includes two operating modes, as described with respect to FIG. 5. For example, the blower 100 may be configured to operate in the first operating mode if the measured power 415 is within the desired power range 500 and operate in the second operating mode if the measured power 415 is outside the desired power range 500, such as below the lower threshold 510. The first operating mode may include controlling a rotational speed of the fan 112 at 630, as will be described with respect to FIG. 7, below.

In at least one example embodiment, the second operating mode includes adjusting a power output of the motor 114, as discussed with respect to FIG. 4. For example, if the measured power 415 is below the lower threshold 510, a gain is applied to the power difference 450 at the amplifier 455 to obtain the first signal 465. Additionally, or alternatively, the integrator 460 integrates the power difference 450 to obtain the second signal 470. The first signal 465 and the second signal 470 are combined at 475 to obtain a control signal 480. The control signal 480 is then used to adjust the power output of the motor 114, as set forth above with respect to FIG. 4.

In at least one example embodiment, after controlling the power output at 625 or controlling the rotational speed of the fan 112 at 630, the method 600 returns to measuring the power output at 610. Accordingly, the method 600 may be executed by the controller 200 to continuously control operation of the blower 100 until operation of the blower 100 is ceased by the operator.

FIG. 7 illustrates a flow chart of a method of operating a blower in accordance with embodiments of the present disclosure.

In at least one example embodiment, the first operating mode includes operating the blower 100 according to a method 700. The method 700 includes receiving a speed setpoint at 707, measuring a speed output at 710, determining whether the measured speed output is the same as the speed setpoint at 715, and adjusting the fan speed at 720 if the measured speed output is not the same as the speed setpoint at 715. One or more portions of the method 700 may be implemented by one or more computing devices, such as the controller 200.

In at least one example embodiment, receiving the speed setpoint at 705 includes receiving a desired speed set by the operator. For example, the operator may set and adjust the speed setpoint using the trigger 118.

In at least one example embodiment, measuring the speed output at 710 includes measuring a rotational speed of the fan 112 of the motor. For example, a sensor may be disposed within the blower housing 108 for measuring the rotational speed of the fan 112.

In at least one example embodiment, determining whether the speed output is the same as the speed setpoint 715 includes determining whether there is a difference between the measured speed output and the speed setpoint. If there is no difference, such as when the measured speed output is the same as the speed setpoint, the method 700 may return to measuring the speed output at 710. For example, the rotational speed of the fan 112 is continuously monitored. If there is a difference between the measured speed output and the speed setpoint, the fan speed may be adjusted at step 720.

In at least one example embodiment, adjusting the fan speed at step 720 includes sending a control signal from the controller 200 to the motor. The control signal may instruct the motor 114 to increase the rotational speed of the fan 112 if the measured speed output is less than the speed setpoint or decrease the rotational speed of the fan 112 if the measured speed output is greater than the speed setpoint.

In at least one example embodiment, the method 700 returns to measuring the speed output at 710 after adjusting the fan speed at 720. In this manner, the controller 200 continuously monitors the rotational speed of the fan 112 to ensure the rotational speed of the fan 112 is maintained at the speed setpoint.

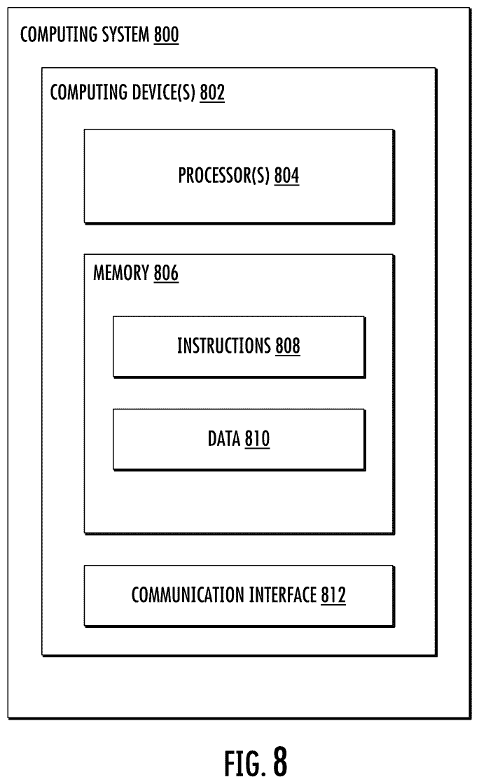

FIG. 8 illustrates a block diagram of an example of a computing system in accordance with embodiments of the present disclosure.

In at least one example embodiment, a computing system 800 can include one or more computing device(s) 802. For example, the one or more computing device(s) 802 may include at least one of the controller 200. Each of the one or more computing device(s) 802 may include one or more processor(s) 804 and one or more memory device(s) 806. The one or more processor(s) 804 can include any suitable processing device, such as a microprocessor, microcontroller, integrated circuit, logic device, or other suitable processing device. The one or more memory device(s) 806 can include one or more computer-readable media, including, but not limited to, non-transitory computer-readable media, RAM, ROM, hard drives, flash drives, or other memory devices.

The one or more memory device(s) 806 can store information accessible by the one or more processor(s) 804, including computer-readable instructions 808 that can be executed by the one or more processor(s) 804. The instructions 808 can be any set of instructions that when executed by the one or more processor(s) 804, cause the one or more processor(s) 804 to perform operations. The instructions 808 can be software written in any suitable programming language or can be implemented in hardware. In some embodiments, the instructions 808 can be executed by the one or more processor(s) 804 to cause the one or more processor(s) 804 to perform operations, such as the operations for generating performing implement and other scans to determine tracking indicia in accordance with processing stages of processing cycle utilizing a plurality of cutting implements, generate state data and association data associated with cutting implements, detect missing cutting implements, and initiate control actions associated with missing control elements as described above, and/or any other operations or functions of the one or more computing device(s) 802.

The memory device(s) 806 can further store data 810 that can be accessed by the one or more processor(s) 804. For example, the data 810 can include state data, association data, processing cycle and/or stages data, and user interface data, etc., as described herein. The data 810 can include one or more table(s), function(s), algorithm(s), model(s), equation(s), etc. according to example embodiments of the present disclosure.

The one or more computing device(s) 802 can also include a communication interface 812 used to communicate, for example, with the other components of system. The communication interface 812 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Further aspects of the invention are provided by one or more of the following embodiments:

A blower includes a blower housing, a motor for driving a fan disposed within the blower housing, and a controller disposed in the blower housing and electrically coupled to the motor for controlling a power output of the motor. The controller is configured to perform a plurality of operations. The plurality of operations include receiving a power setpoint, receiving a measured power, comparing the power setpoint and the measured power to obtain a power difference, generating a control signal based on the power difference, and adjusting the power output of the motor based on the control signal.

The blower of any one or more embodiments, wherein the plurality of operations further include applying a slew limit to the power setpoint received.

The blower of any one or more embodiments, wherein the receiving the measured power includes receiving a current output from the motor, applying a filter to the current output to obtain a filtered current output, receiving a voltage output from the motor, and multiplying the filtered current output and the voltage output by the motor to obtain the measured power.

The blower of any one or more embodiments, wherein the filter includes a low pass filter.

The blower of any one or more embodiments, wherein the filter includes an exponential moving average filter.

The blower of any one or more embodiments, wherein the generating the control signal includes applying a gain to the power difference to obtain a first signal, integrating the power difference to obtain a second signal, and combining the first signal and the second signal to obtain the control signal.

The blower of any one or more embodiments, wherein the generating the control signal further includes controlling, via an output limiter, a voltage of the control signal; and controlling, via a slew limiter, a rate of change of the voltage of the control signal.

The blower of any one or more embodiments, wherein the adjusting the power output of the motor includes adjusting a voltage output of the motor based on the control signal.

The blower of any one or more embodiments, wherein adjusting the power output of the motor includes adjusting a rotational speed of the fan.

The blower of any one or more embodiments, wherein adjusting the rotational speed of the fan includes increasing the rotational speed of the fan if the measured power is less than the power setpoint and decreasing the rotational speed of the fan if the measured power is greater than the power setpoint.

The blower of any one or more embodiments, wherein the controller includes a proportional and integral controller.

The blower of any one or more embodiments, wherein the controller is configured to maintain a constant power output.

The blower of any one or more embodiments, wherein the plurality of operations are a first plurality of operations, and the controller is further configured to compare the measured power to a desired power range and operate in a first mode if the measured power is within the desired power range. The first mode includes a second plurality of operations. The second plurality of operations include receiving a rotational speed setpoint of a fan of a motor, receiving a measured rotational speed of the fan of the motor, comparing the rotational speed setpoint to the measured rotational speed to obtain a rotational speed difference, and adjusting a rotational speed of the fan of the motor based on the rotational speed difference obtained. The controller is also configured to operate in a second mode if the measured power is outside of the desired power range. The second mode includes the first plurality of operations.

A method for controlling a motor of a blower includes receiving a power setpoint, receiving a measured power, comparing the power setpoint and the measured power to obtain a power difference, generating a control signal based on the power difference, and adjusting a power output of the motor based on the control signal.

The method of any one or more embodiments, further including applying a slew limit to the power setpoint received.

The method of any one or more embodiments, wherein the receiving the measured power includes receiving a current output from the motor, applying a filter to the current output to obtain a filtered current output, receiving a voltage output from the motor, and multiplying the filtered current output and the voltage output by the motor to obtain the measured power.

The method of any one or more embodiments, further including applying a gain to the power difference to obtain a first signal, integrating the power difference to obtain a second signal, and combining the first signal and the second signal to obtain the control signal.

The method of any one or more embodiments, wherein the generating the control signal further includes controlling, via an output limiter, a voltage of the control signal; and controlling, via a slew limiter, a rate of change of the voltage of the control signal.

The method of any one or more embodiments, wherein the adjusting the power output of the motor includes adjusting a voltage output of the motor based on the control signal.

The method of any one or more embodiments, further including comparing the measured power to a desired power range, operating in a first mode if the measured power is within the desired power range, and operating in a second mode if the measured power is outside the desired power range. The first mode includes receiving a rotational speed setpoint of a fan of a motor, receiving a measured rotational speed of the fan of the motor, comparing the rotational speed setpoint to the measured rotational speed to obtain a rotational speed difference, and adjusting a rotational speed of the fan of the motor based on the rotational speed difference obtained. The second mode includes the receiving the power setpoint, the receiving the measured power, the comparing the power setpoint and the measured power, the generating the control signal, and the adjusting the power output.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blower, comprising:
a blower housing;
a motor for driving a fan disposed within the blower housing; and
a controller disposed in the blower housing and electrically coupled to the motor for controlling a power output of the motor, the controller configured to perform a plurality of operations, the plurality of operations comprising:
receiving a power setpoint,
receiving a measured power,
comparing the power setpoint and the measured power to obtain a power difference,
generating a control signal based on the power difference, and
adjusting the power output of the motor based on the control signal.

2. The blower of claim 1, wherein the plurality of operations further comprise applying a slew limit to the power setpoint received.

3. The blower of claim 1, wherein the receiving the measured power comprises:
receiving a current output from the motor;
applying a filter to the current output to obtain a filtered current output;
receiving a voltage output from the motor; and
multiplying the filtered current output and the voltage output by the motor to obtain the measured power.

4. The blower of claim 3, wherein the filter comprises a low pass filter.

5. The blower of claim 3, wherein the filter comprises an exponential moving average filter.

6. The blower of claim 1, wherein the generating the control signal comprises:
applying a gain to the power difference to obtain a first signal;
integrating the power difference to obtain a second signal; and
combining the first signal and the second signal to obtain the control signal.

7. The blower of claim 6, wherein the generating the control signal further comprises:
controlling, via an output limiter, a voltage of the control signal; and
controlling, via a slew limiter, a rate of change of the voltage of the control signal.

8. The blower of claim 1, wherein the adjusting the power output of the motor includes adjusting a voltage output of the motor based on the control signal.

9. The blower of claim 1, wherein adjusting the power output of the motor includes adjusting a rotational speed of the fan.

10. The blower of claim 9, wherein adjusting the rotational speed of the fan comprises:
increasing the rotational speed of the fan if the measured power is less than the power setpoint; and
decreasing the rotational speed of the fan if the measured power is greater than the power setpoint.

11. The blower of claim 1, wherein the controller comprises a proportional and integral controller.

12. The blower of claim 1, wherein the controller is configured to maintain a constant power output.

13. The blower of claim 1, wherein:
the plurality of operations are a first plurality of operations; and
the controller is further configured to:
compare the measured power to a desired power range, and
operate in a first mode if the measured power is within the desired power range, the first mode including a second plurality of operations, the second plurality of operations comprising:
receiving a rotational speed setpoint of a fan of a motor,
receiving a measured rotational speed of the fan of the motor,
comparing the rotational speed setpoint to the measured rotational speed to obtain a rotational speed difference, and
adjusting a rotational speed of the fan of the motor based on the rotational speed difference obtained; and
operate in a second mode if the measured power is outside of the desired power range, the second mode including the first plurality of operations.

14. A method for controlling a motor of a blower, comprising:
receiving a power setpoint;
receiving a measured power;
comparing the power setpoint and the measured power to obtain a power difference;
generating a control signal based on the power difference; and
adjusting a power output of the motor based on the control signal.

15. The method of claim 14, further comprising applying a slew limit to the power setpoint received.

16. The method of claim 14, wherein the receiving the measured power comprises:
receiving a current output from the motor;
applying a filter to the current output to obtain a filtered current output;
receiving a voltage output from the motor; and
multiplying the filtered current output and the voltage output by the motor to obtain the measured power.

17. The method of claim 14, further comprising:
applying a gain to the power difference to obtain a first signal;
integrating the power difference to obtain a second signal; and
combining the first signal and the second signal to obtain the control signal.

18. The method of claim 14, wherein the generating the control signal further comprises:
controlling, via an output limiter, a voltage of the control signal; and
controlling, via a slew limiter, a rate of change of the voltage of the control signal.

19. The method of claim 14, wherein the adjusting the power output of the motor includes adjusting a voltage output of the motor based on the control signal.

20. The method of claim 14, further comprising:
comparing the measured power to a desired power range;
operating in a first mode if the measured power is within the desired power range, the first mode including:
receiving a rotational speed setpoint of a fan of a motor,
receiving a measured rotational speed of the fan of the motor,
comparing the rotational speed setpoint to the measured rotational speed to obtain a rotational speed difference, and
adjusting a rotational speed of the fan of the motor based on the rotational speed difference obtained; and
operating in a second mode if the measured power is outside the desired power range;
wherein the second mode includes the receiving the power setpoint, the receiving the measured power, the comparing the power setpoint and the measured power, the generating the control signal, and the adjusting the power output.
